(19) United States
(12) Patent Application Publication
(10) Pub. No.: US 2022/0197587 A1
(43) Pub. Date: Jun. 23, 2022

(54) SURFACE PRESENTATIONS

(71) Applicant: Hewlett-Packard Development Company, L.P., Spring, TX (US)

(72) Inventor: Sook Min Park, Palo Alto, CA (US)

(73) Assignee: Hewlett-Packard Development Company, L.P., Spring, TX (US)

(21) Appl. No.: 17/606,084

(22) PCT Filed: Jul. 31, 2019
(86) PCT No.: PCT/US2019/044324

§ 371 Date: Oct. 25, 2021

(51) Int. Cl. G06F 3/14; G06V 30/19; H04N 9/31; G06V 30/14; G06V 30/32; H04L 65/403

(52) U.S. Cl. CPC G06F 3/1454; G06V 30/19; H04L 65/403; G06V 30/14; G06V 30/32; H04N 9/31

(57) ABSTRACT

Examples of computing devices are described herein. In some examples, a computing device includes machine-readable instructions stored in a non-transitory storage medium. In some examples, the instructions are executable by a processor to determine a content feed using artificial intelligence based on a captured image of a writing surface. In some examples, the instructions are executable to present the content feed with a representation of the writing surface.

### BACKGROUND

The use of electronic devices has expanded. For example, a variety of computing devices are used for work, communication, and entertainment. Computing devices may be linked to a network to facilitate communication between users. For example, a smart phone may be used to send and receive phone calls, email, or text messages. A tablet device may be used to watch Internet videos. A desktop computer may be used to send an instant message over a network. Each of these types of communication offers a different user experience.

### BRIEF DESCRIPTION OF THE DRAWINGS

FIG. 1 is a block diagram of an example of a computing device that may be used for surface presentations;

FIG. 2 is a block diagram illustrating an example of a computing device that may be utilized for surface presentations;

FIG. 3 is a flow diagram illustrating an example of a method for surface presentations; and

FIG. 4 is a diagram illustrating an example of a computing device a surface and a remote computing device.

### DETAILED DESCRIPTION

Some approaches to collaboration with devices are limited in various aspects. For example, some approaches do not allow a remote participant to contribute input for presentation on a surface. Accordingly, collaboration with remote participants may be limited and less effective than in-person collaboration.

Some examples of the techniques described herein may improve virtual collaboration. For example, some of the techniques described herein may enable local and remote participants to collaborate more effectively.

Some examples of the techniques described herein may provide real-time editing functionality with participants contributing to whiteboard content remotely. For example, input contributed from remote participants may be captured through input devices such as cameras, touch mats, touch screen devices, keyboards, mice, controllers, etc. The input may be projected on a surface such as a whiteboard. For example, this functionality may allow editing on a projected surface, which may enable remote participants to collaborate on the same surface.

Some examples of the techniques described herein may utilize computer vision to convert handwritten content on the surface (e.g., whiteboard) into text. This may improve legibility and/or visibility.

Some examples of the techniques described herein may provide content feeds using artificial intelligence (Al). The content feeds may be related to the subject(s) of the collaboration. A content feed is information related to a subject. A content feed may be updatable and/or periodically updated. For example, a display on the surface (e.g., whiteboard) may provide content feeds to the participants based on handwritten input on the surface. The content feeds may show, for example, industry trends and innovation, which may aid the collaborative process. In some examples, the subject of the content feeds may be customized.

Some examples of the techniques described herein may utilize three-dimensional (3D) media. For example, 3D video conferencing may be provided using a 3D scanner and a projector.

Some examples of the techniques described herein may be beneficial. For instance, some examples may reduce traveling cost and increase employee productivity by enabling employees to participate in live collaboration remotely. Some examples may enable educational institutions to expand by providing remote collaboration and/or 3D real-time projection of lectures, which may enable distant students to experience and/or participate in the classroom.

Throughout the drawings, identical reference numbers may designate similar, but not necessarily identical, elements. Similar numbers may indicate similar elements. When an element is referred to without a reference number, this may refer to the element generally, without necessary limitation to any particular drawing figure. The drawing figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

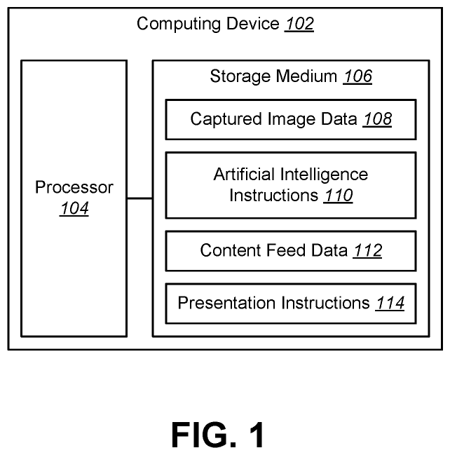

FIG. 1 is a block diagram of an example of a computing device 102 that may be used for surface presentations. The computing device 102 may be an electronic device, such as a projector device, personal computer, a server computer, a smartphone, a tablet computer, etc.

The computing device 102 may include and/or may be coupled to a processor 104 and/or a storage medium 106. In some examples, the computing device 102 may be in communication with (e.g., coupled to, have a communication link with) a remote server and/or remote computing devices. The computing device 102 may include additional components (not shown) and/or some of the elements described herein may be removed and/or modified without departing from the scope of this disclosure.

The processor 104 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the storage medium 106. The processor 104 may fetch, decode, and/or execute instructions (e.g., artificial intelligence instructions 110) stored in the storage medium 106. In some examples, the processor 104 may include an electronic circuit or circuits that include electronic components for performing a function or functions of the instructions (e.g., artificial intelligence instructions 110). In some examples, the processor 104 may perform one, some, or all of the functions, operations, elements, methods, etc., described in connection with one, some, or all of FIGS. 1-4.

The storage medium 106 may be any electronic, magnetic, optical, or other physical storage device that contains or stores electronic information (e.g., instructions and/or data). The storage medium 106 may be, for example, Random Access Memory (RAM), Electrically Erasable Programmable Read-Only Memory (EEPROM), a storage device, an optical disc, and the like. In some examples, the storage medium 106 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the storage medium 106 may be a non-transitory tangible machine-readable storage medium, where the term “non-transitory” does not encompass transitory propagating signals. In some examples, the storage medium 106 may include multiple devices (e.g., a RAM card and a solid-state drive (SSD)).

In some examples, the computing device 102 may include a communication interface (not shown in FIG. 1) through which the processor 104 may communicate with an external device or devices (not shown), for instance, to receive and store information (e.g., input data) corresponding to the computing device 102, corresponding to a remote server device, and/or corresponding to a remote computing device(s). The communication interface may include hardware and/or machine-readable instructions to enable the processor 104 to communicate with the external device or devices. The communication interface may enable a wired or wireless connection to the external device or devices. In some examples, the communication interface may further include a network interface card and/or may also include hardware and/or machine-readable instructions to enable the processor 104 to communicate with various input and/or output devices, such as projector(s), camera(s), a touch sensitive mat, a keyboard, a mouse, a display, another computing device, electronic device, smart phone, tablet device, etc., through which a user may input instructions and/or data into the computing device 102.

In some examples, the storage medium 106 may include captured image data 108, artificial intelligence instructions 110, content feed data 112, and/or presentation instructions 114. Instructions stored in the storage medium 106 may be machine-readable instructions. Machine-readable instructions are instructions that are readable by a processor, computer, or other device for execution. For example, the artificial intelligence instructions 110 and/or the presentation instructions 114 may be readable by the processor 104 for execution.

In some examples, the storage medium 106 of the computing device 102 may store captured image data 376. For example, the captured image data 108 may include an image or images (e.g., video) captured by a camera or cameras. A captured image is a digital image captured with a camera. In some examples, the cameras may be included in the computing device 102. In some examples, the camera(s) may be coupled to the computing device 102 and/or may be in communication with the computing device.

In some examples, the captured image(s) may include a captured image or images of a writing surface. A writing surface is a surface for writing. For instance, a writing surface may show handwritten content. Examples of a writing surface may include a whiteboard, chalkboard, paper, touch-sensitive mat, etc.

In some examples, the processor 104 may execute the artificial intelligence instructions 110 to determine a content feed using artificial intelligence based on a captured image of a writing surface. Artificial intelligence is a technique for a device to make a determination or determinations. For example, artificial intelligence may be implemented as a set of instructions and/or data that may be utilized by a processor to make determination(s). Examples of artificial intelligence may include machine learning models, artificial neural networks, classifier models, etc. For instance, artificial intelligence may be trained and/or learn to improve determinations based on data. In some examples, determining the content feed may include recognizing writing, searching for content, and/or selecting content to include in the content feed. For instance, the artificial intelligence may obtain search results related to writing on the writing surface. The artificial intelligence may select a search result or search results to include in the content feed. In some examples, the content feed may include a list of information (e.g., text, web links, images, etc.) related to the writing on the writing surface. The content included in the content feed may be stored as content feed data 112.

In some examples, the processor 104 may execute the artificial intelligence instructions 110 to recognize writing on the writing surface based on the captured image. For example, the artificial intelligence may be trained to recognize shapes, symbols, characters, and/or words written on the writing surface. For instance, the artificial intelligence may convert the writing into text (e.g., string text, data characters, etc.). In some examples, the artificial intelligence may determine a subject or subjects of the writing. A subject is a topic of writing. For example, a subject may summarize the overall topic of writing.

In some examples, the processor 104 may execute the artificial intelligence instructions 110 to use the artificial intelligence to determine the content feed based on the recognized writing. For example, the recognized writing may be utilized to search and/or query a source or sources of information for information related to the subject of the writing. Examples of sources of information may include databases, web servers, websites, web services, files, etc.

In some examples, the processor 104 may execute the artificial intelligence instructions 110 to select content from a network based on the recognized writing for the content feed. For instance, the recognized writing may be utilized to send a search request (e.g., search request(s) and/or a query or queries) to a network of devices. The search request may include characters and/or words from the recognized writing. For instance, the search request may include the subject from the recognized writing. Examples of networks include the Internet, local area network (LAN), wide area network (WAN), etc. In some examples, the search request may be sent to a web server or web servers that provide a search engine or search engines. The computing device 102 may receive the results of the search request(s). In some examples, selecting content for the content feed may include selecting a result or results from the search request(s). For instance, the artificial intelligence may select a result or results from each of a set of information sources. In some examples, the artificial intelligence may select result(s) based on relevance (e.g., how closely the result matches the subject of the recognized writing), age (e.g., how recent the result is), and/or information source (e.g., whether the information source has previously provided content that has been selected from the content feed, whether the information source is indicated as high quality and/or trusted, etc.). For instance, the artificial intelligence may select results from industry publications, industry analysis sources, news sources, forums, etc. In some examples, the selected content may be stored as content feed data 112.

In some examples, the processor 104 may execute the presentation instructions 114 to present the content feed with a representation of the writing surface. A representation of the writing surface is an image and/or data corresponding to the writing surface. In some examples, the representation of the writing surface may be an interactive surface or user interface. In some examples, the content feed may be presented as a portion of the representation of the writing surface. For instance, the content feed may be presented as a panel, window, or sub-window of the representation of the writing surface. For example, the computing device 102 may produce an image or user interface that represents the writing surface with a panel that includes the content feed.

In some examples, presenting the content feed may include sending the content feed to a device or devices for presentation. For example, the processor 104 may send the content feed to a projector, monitor, touch screen, remote computing device, etc. The processor 104 may present the content feed using a projector. In some examples, the computing device 102 may include a projector for presenting the content feed. In some examples, the representation of the writing surface may include writing indicated in the captured image. In some examples, the writing in the representation of the writing surface may be projected on top of the corresponding actual writing on the writing surface.

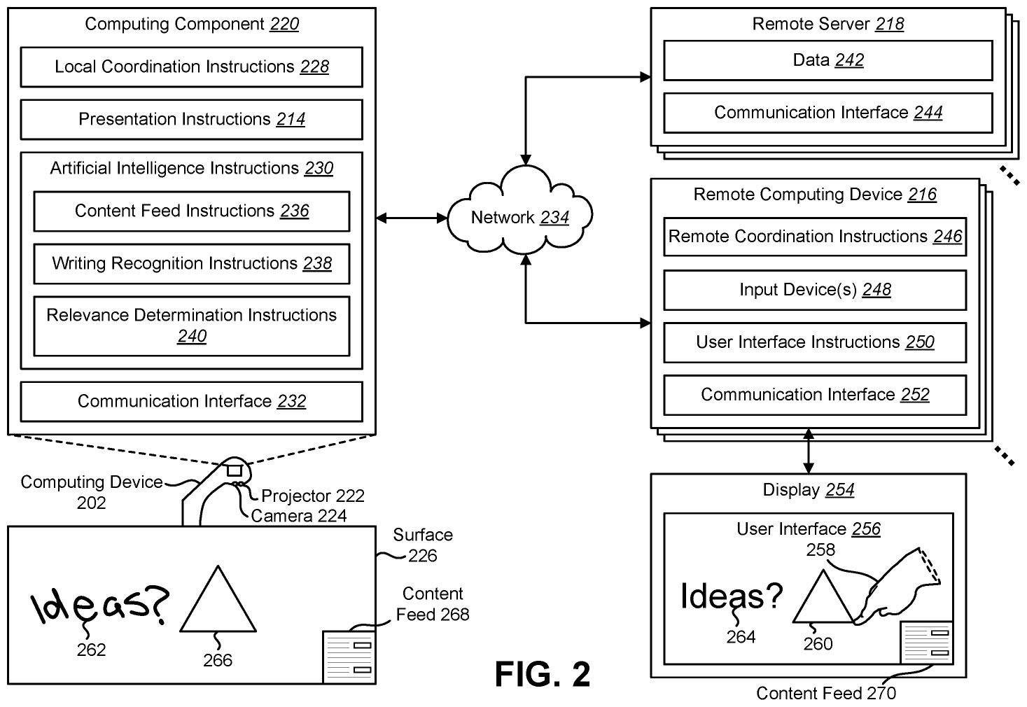

FIG. 2 is a block diagram illustrating an example of a computing device 202 that may be utilized for surface presentations. The computing device 202 illustrated in FIG. 2 may be an example of the computing device 102 described in connection with FIG. 1 in some examples. FIG. 2 also illustrates examples of a plurality of remote servers 218 and a plurality of remote computing devices 216.

In the example illustrated in FIG. 2, the computing device 202 includes a computing component 220, a projector 222, and a camera 224. The computing component 220 is a component of the computing device 202 for performing computations. In some examples, the computing device 202 and/or the computing component 220 may include a processor or processors and a memory or memories. A memory may be in electronic communication with the processor. For instance, the computing component 220 may include a processor to execute instructions stored in the memory.

The projector 222 is a device for projecting images or image data. For example, the projector 222 may be a digital light projector that receives image data from the computing component 220 and projects the image data. For instance, the projector 222 may include a light source, image controller, and/or lens. Examples of the projector 222 include digital light processing (DLP) projectors and liquid crystal display (LCD) projectors. The projector 222 may be included in the computing device 202. For example, the projector 222 may be housed in the computing device 202 with the computing component 220 and/or camera 224. In some examples, the housing may include an arm to extend over a surface 226. For instance, the projector 222 may be suspended in the housing of the computing device 202 to project image data onto the surface 226.

The camera 224 is a device for capturing optical images (e.g., video) and/or depth images. For instance, the camera 224 may include a sensor or sensors and a lens or lenses. In some examples, the sensor(s) may include light sensors, infrared (IR) sensors, and/or depth sensors. Examples of the camera 224 include digital cameras, time-of-flight (TOF) cameras, etc. The camera 224 may be included in the computing device 202. For example, the camera 224 may be housed in the computing device 202 with the computing component 220 and/or projector 222. For instance, the camera 224 may be suspended in the housing of the computing device 202 to capture images of the surface 226. The camera 224 may provide the images to the computing component 220 in some examples.

The computing component 220 may include local coordination instructions 228, presentation instructions 214, artificial intelligence instructions 230, and/or a communication interface 232. For example, the local coordination instructions 228, the presentation instructions 214, and/or the artificial intelligence instructions 230 may be stored in memory. The communication interface 232 may include hardware and/or machine-readable instructions to enable the computing device 202 to communicate with the remote server(s) 218 and/or the remote computing device(s) 216 via a network 234. The communication interface 232 may enable a wired or wireless connection to the network 234, to the remote server(s) 218, and/or to the remote computing device(s) 216. Examples of the network 234 include the Internet, local area network(s) (LAN(s)), wide area networks (WAN(s)), and/or personal area networks (PAN(s)), including combinations thereof.

In some examples, the artificial intelligence instructions 230 may be an example of the artificial intelligence instructions 110 described in connection with FIG. 1. In some examples, the artificial intelligence instructions 230 may include content feed instructions 236, writing recognition instructions 238, and/or relevance determination instructions 240. In some examples, the artificial intelligence instructions 230 may include instructions for an artificial intelligence engine or artificial intelligence engines. An artificial intelligence engine is a set of instructions and/or data to implement an artificial intelligence. For example, the content feed instructions 236 may correspond to a first artificial intelligence engine, the writing recognition instructions 238 may correspond to a second artificial intelligence engine, and the relevance determination instructions 240 may correspond to a third artificial intelligence engine. In some examples, the content feed instructions 236, the writing recognition instructions 238, and/or the relevance determination instructions 240 may be included in one artificial intelligence engine.

In some examples, the camera 224 may be utilized to capture an image of the surface 226. The surface 226 may be an example of the writing surface described in connection with FIG. 1. Examples of the surface 226 may include a white board, chalkboard, paper, touch-sensitive mat, etc. In the example illustrated in FIG. 2, writing 262 is on the surface 226. The captured image may include the writing 262 on the surface 226. For instance, the captured image may indicate or depict the writing 262 (e.g., handwriting).

In some examples, the computing device 202 (e.g., processor) may execute the presentation instructions 214 to project an image of the writing onto the surface 226 using the projector 222. For example, an image of the writing 262 may be projected on top of the writing 262 on the surface 226.

In some examples, the computing device 202 may execute the writing recognition instructions 238 to recognize writing 262 on the surface 226 based on a captured image. For instance, the writing recognition instructions 238 may provide artificial intelligence that is trained to recognize writing, such as letters, characters, words, shapes, and/or lines, etc. For example, a user may write on a whiteboard with a dry-erase marker. In some examples, the artificial intelligence (e.g., a writing recognition artificial intelligence engine) may recognize each letter written on the surface.

In some examples, the computing device 202 (e.g., processor) may generate text based on the recognized writing. In some examples, text is an electronic representation of a letter or letter(s) and/or symbol or symbol(s). In some examples, the text may be based on a predetermined font. For example, the computing device 202 (e.g., processor) may produce a string of characters corresponding to the recognized letters. Converting the writing 262 to text may improve legibility and/or may reduce the amount of data used to represent the writing 262 (for storage and/or communication, for instance). In some examples, the computing device 202 (e.g., processor) may present the text. For example, the computing device 202 may present the text on a display and/or utilize the projector 222 to project the text onto the surface 226. In some examples, the computing device 202 may send the text to a remote computing device(s) 216. For example, the computing device 202 may utilize the communication interface 232 to send the text to the remote computing device(s) 216 via the network 234. In some examples, the remote computing device(s) 216 may present the received text 264 on a display 254 (e.g., on a user interface 256 presented on the display 254).

In some examples, the computing device 202 (e.g., processor) may receive a set of inputs from a set of collaborating remote computing devices 216. In some examples, the set of inputs may include image data, text data, links, and/or other data. In some examples, the computing device 202 (e.g., processor) may execute the relevance determination instructions 240 to determine a relevance for each of the set of inputs. A relevance is a numerical rating or score that indicates relatedness and/or usefulness. For example, the relevance determination instructions 240 may be executed to provide artificial intelligence to determine a degree of relevance for each of the set of inputs. For instance, relevance may be determined in relation to an input or inputs to the computing device 202 from the camera 224 and/or from a remote computing device(s) 216. For example, the artificial intelligence may determine a subject (e.g., topic) of a collaboration based on captured image(s) (e.g., recognized writing and/or text) from the camera 224 and/or based on input(s) from the remote computing device(s) 216. The artificial intelligence may provide the relevance (e.g., rating or score) for each of the set of inputs based on the subject. A higher relevance may be determined for inputs that are more related to the subject and/or that are determined to be more useful by the artificial intelligence. In some examples, the artificial intelligence may be trained to determine relevance further based on a remote computing device 216 and/or user. For example, if past inputs from a user of a remote computing device 216 have previously been often removed from a collaboration session and/or rated less useful by other users, the artificial intelligence may tend to provide lower relevance to inputs originating from that remote computing device 216 and/or user.

In some examples, the computing device 202 (e.g., processor) may filter out an input with a relevance that is less than a relevance threshold. A relevance threshold is a threshold for determining whether an input is germane to another input and/or a group of inputs (e.g., a collaboration). An input may be germane in a case that the input is greater than or equal to the relevance threshold. The relevance threshold may be predetermined, adaptive, and/or set by a user. For example, a relevance threshold may be set to 20%, 40%, 60%, or another value. In a case that an input has a relevance that is less than the relevance threshold, the computing device 202 (e.g., processor) may filter out the input. Filtering out the input may include suppressing the input, not presenting the input, etc.

In some examples, the computing device 202 (e.g., processor) may receive, from the camera 224, a first input corresponding to a surface 226. For example, the computing device 202 may use the camera 224 to capture the first input (e.g., an image) of the surface 226. In some examples, the computing device 202 may receive a second input from a collaborating remote computing device 216. For example, the computing device 202 may receive image data, text, links, etc., from the remote computing device 216 via the network 234. In the example illustrated in FIG. 2, an example of the second input is a triangle shape 260 entered by a user 258. The computing device 202 (e.g., processor) may determine, using artificial intelligence, whether the second input is germane to the first input. For example, the computer (e.g., processor) may execute the writing recognition instructions 238 to recognize writing 262 of the first input. The computing device 202 (e.g., processor) may execute the relevance determination instructions 240 to determine whether the relevance of the second input based on the recognized writing of the first input. For example, the computing device 202 (e.g., processor) may determine a relatedness between the recognized writing of the first input (e.g., a subject of the recognized writing of the first input) and the second input. For instance, a subject of the recognized writing of the first input may be an “ideas” interrogatory. Because this subject is very broad, a wide range of inputs may have high relevance. The computing device 202 (e.g., processor) may compare the relevance of the second input to a relevance threshold to determine whether the second input is germane. For example, if the relevance of the second input is greater than or equal to the first input, then the second input is germane to the first input. For instance, the computing device 202 may determine whether the relevance of a triangle shape is greater than or equal to a relevance threshold. In some examples, the computing device 202 may present, using the projector 222, the second input on the surface 226 in response to determining that the second input is germane to the first input. For example, the computing device 202 (e.g., processor) may execute the presentation instructions 214 to present a germane input. For instance, in a case that the relevance of the input triangle shape 260 is greater than or equal to the relevance threshold, the computing device 202 may present the triangle shape 266 on the surface 226 using the projector 222.

In some examples, the computing device 202 (e.g., processor) may execute the content feed instructions 236 to determine a content feed based on an input or inputs. For example, the computing device 202 may determine a content feed based on a first input from the camera 224 and/or based on an input or inputs from remote computing device(s) 216. In some examples, determining the content feed may be performed as described in connection with FIG. 1. For example, the computing device 202 may utilize recognized writing from an input from the camera 224 and/or may utilize an input or inputs from remote computing device(s) 216 to obtain search results from a remote server 218 or remote servers 218. For instance, the computing device 202 (e.g., processor) may execute the content feed instructions 236 to send a search request to the remote server(s) 218 (over the network 234, for example). The remote server(s) may include data 242 and/or indices of data. The remote server(s) 218 may respond to the computing device 202 by sending search results related to the data 242 via the network 234. In some examples, the computing device 202 (e.g., processor) may execute the content feed instructions 236 to select a search result or search results for inclusion in the content feed.

In some examples, the computing device 202 (e.g., processor) may present, using the projector 222, the content feed 268 on the surface. For example, the content feed 268 may illustrate the selected search result(s). For instance, the content feed 268 may include text, images, links, etc. In some examples, the computing device 202 may update the search results and/or content feed 268 periodically and/or when triggered by an additional input or inputs. In some examples, the computing device 202 may send content feed information to the remote computing device(s) 216. In some examples, the remote computing device(s) 216 may present the content feed 270 on a display 254 (e.g., on a user interface 256).

In some examples, the local coordination instructions 228 may be executed by the processor to facilitate data exchange between the computing device 202 and the remote server 218 and/or between the computing device 202 and the remote computing device(s) 216. For example, the computing device 202 may receive a first input corresponding to the surface 226 from the camera 224. The first input may indicate an image object. An image object is an object based on input from the camera 224. For example, the image object may be data that is formatted for transfer and/or collaboration. In some examples, the computing device 202 may execute the local coordination instructions 228 to produce the image object based on the first input from the camera 224. In some examples, formatting the first input may include removing a portion of the first input, removing background from the first input, formatting the first input for transparency, formatting color of the first input (e.g., color coding the image data), labeling the first input, and/or formatting the first input for an operation. The computing device 202 may send the image object to the remote server(s) 218 and/or to the remote computing device(s) 216. For example, the computing device 202 may send text based on recognized writing.

In some examples, the computing device 202 may execute the local coordination instructions 228 to receive (e.g., stream) data or objects from the remote server(s) 218 and/or from the remote computing device(s) 216. For example, a remote computing device 216 may send (e.g., stream) a second input or objects corresponding to a second input to the remote server(s) 218 and/or to the computing device 202. In some examples, the computing device 202 may render collaborative display data based on the received second input and/or objects corresponding to a second input.

In some examples, the computing device 202 may include rendering instructions that may be included in the presentation instructions 214 or may be separate from the presentation instructions 214. For example, the computing device 202 may execute the rendering instructions to render the collaborative display data. In some examples, the computing device 202 may render a portion of the first input semi-transparently. For example, the computing device 202 may render, semi-transparently, image data or a portion of image data from the first input from the camera 224. In some examples, this may allow the image data or a portion of the image data from the camera 224 to be presented while reducing obstruction of other presented data (e.g., second input from the surface 226 and/or second input from a remote computing device 216). In some examples, an image object that is rendered semi-transparently or that is formatted to be rendered semi-transparently may be sent to the remote server 218 and/or the remote computing devices 216.

In some examples, the computing device 202 may render a portion of a figure depicted by the first input. A figure may be a physical object. An example of a physical object is a body or limb of a user. For example, the computing device 202 may render a portion of a body or limb of a user depicted by the first input from the camera 224. For instance, first input from the camera 224 may depict a user's arm below the elbow or wrist. The computing device 202 may detect or recognize a portion of the first input corresponding to the user's hand and remove the image data that depicts the user's arm between the wrist and elbow. For instance, the computing device 202 may remove image data that depicts a user except for a user's hand or finger. In some examples, the computing device 202 may remove image data except for image data that depicts a stylus. In some examples, this may allow a portion of the image data from the camera 224 to be presented while reducing obstruction of other presented data (e.g., second input from a remote computing device 216). For instance, this may allow a user to point to a part of the collaborative display data on the surface 226. In some examples, an image object that is rendered with a portion of a figure or that is formatted to be rendered with a portion of a figure may be sent to the remote server 218 and/or the remote computing devices 216.

In some examples, the computing device 202 may execute the presentation instructions 214 to produce a user interface. In some examples, the user interface may be provided to the projector 222. In some examples, the user interface may be presented on the surface 226 or another surface. For example, the user interface may be presented on the surface 226 and the computing device 202 may detect interaction with the user interface based on image(s) of the surface 226 captured by the camera 224.

In some examples, the computing device 202 may be in communication with or coupled to a display (not shown) or other local device (e.g., tablet, touch screen, etc.). In some examples, the computing device 202 may present the user interface on the display or local device. In some examples, an input or inputs may be provided to the computing device from the display or local device. For example, the local device may provide writing or drawing inputs using a touchscreen or touch sensitive mat. The local device may provide inputs for a user interface control or controls described herein in some examples.

The remote server(s) 218 may include a processor and memory. Each of the remote server(s) 218 may include data 242 and/or a communication interface 244. For example, the data 242 may be stored in memory. In some examples, the remote server 218 may execute instructions to receive search requests and/or to send search results (e.g., data 242 and/or information about the data 242) to the computing device 202. The communication interface 244 may include hardware and/or machine-readable instructions to enable the remote server 218 to communicate with the computing device 202 and/or the remote computing devices 216 via a network 234. The communication interface 244 may enable a wired or wireless connection to the computing device 202 and/or to the remote computing devices 216.

The remote computing devices 216 may each include a processor and memory (e.g., a non-transitory computer-readable medium). Each of the remote computing devices 216 may include an input device or input devices 248, remote coordination instructions 246, user interface instructions 250, and/or a communication interface 252. In some examples, the user interface instructions 250 may be stored in the memory (e.g., non-transitory computer-readable medium) and may be executable by the processor. Each communication interface 252 may include hardware and/or machine-readable instructions to enable the respective remote computing device 216 to communicate with the remote server 218 and/or the computing device 202 via the network 234. The communication interface 252 may enable a wired or wireless connection with the computing device 202 and/or with the remote server 218.

The input device(s) 248 may capture or sense inputs. Examples of the input device(s) 248 include touch screens, touch pads, mice, keyboards, electronic styluses, cameras, controllers, etc. In some examples, the input device(s) 248 may convert inputs from the input device(s) 248 into objects and/or image data. For instance, the input device(s) 248 may utilize the inputs from the input device(s) 248 to determine data and/or object(s) (e.g., writing objects, image objects, character objects, etc.). The data and/or object(s) may be sent to the computing device 202.

In some examples, a remote computing device 216 may include and/or may be coupled to a display 254. For example, the display 254 may be integrated into the remote computing device 216 or may be a separate device. The display 254 is a device for presenting electronic images. Some examples of the display 254 may include liquid crystal displays (LCDs), light emitting diode (LED) displays, organic light emitting diode (OLED) displays, plasma displays, touch screens, monitors, projectors, etc. In some examples, the display may present a user interface 256.

In some examples, the remote computing device(s) 216 may include remote coordination instructions 246. The remote computing device 216 may execute the remote coordination instructions 246 to coordinate with the remote server 218 and/or the computing device 202. For example, the remote coordination instructions 246 may be executed to send a second input(s) or object(s) based on the second input(s) to the remote server 218 and/or the computing device 202. In some examples, the remote coordination instructions 246 may be executed to receive a first input(s) or object(s) based on the first input(s) from the remote server 218 and/or the computing device 202. For instance, the remote computing device(s) 216 may receive a first input from a camera 224 and/or object(s) based on the first input from the remote server 218 and/or computing device 202.

In some examples, the remote computing device 216 may render and/or present a portion of the first input semi-transparently. For example, the remote computing device 216 may render, semi-transparently, image data or a portion of image data from the first input from the camera 224. In some examples, this may allow the image data or a portion of the image data from the camera 224 to be presented while reducing obstruction of other presented data (e.g., second input from a remote computing device 216).

In some examples, the remote computing device 216 may render and/or present a portion of a figure depicted by the first input. For example, the remote computing device 216 may render a portion of a body or limb of a user 258 depicted by the first input from the camera 224. For instance, the remote computing device 216 may present a hand of a user captured by the camera 224 without showing the arm of the user. In some examples, this may allow a portion of the image data from the camera 224 to be presented while reducing obstruction of other presented data. For example, an object (e.g., received text 264) from the surface 226 may be presented without being obstructed by the user's arm.

In some examples, the remote computing device 216 may execute the user interface instructions 250 to produce a user interface 256. In some examples, the user interface 256 may be presented on the display 254.

In some examples, a second input or inputs may be provided to the remote computing device 216 from the user interface 256. For example, writing or drawing inputs may be provided using a touchscreen. In some examples, the user interface 256 may provide inputs for a user interface control or controls.

In some examples, the local coordination instructions 228 may be an example of a collaboration application that may be executed to facilitate collaboration with the remote computing device(s) 216. In some examples, the remote coordination instructions 246 may be another example of a collaboration application that may be executed to facilitate collaboration with the computing device 202. In some examples, a server or servers may provide a platform that interoperates with a collaboration application on the computing device 202 and/or on the remote computing device(s) 216 to facilitate (e.g., intermediate, relay) collaboration between the computing device 202 and the remote computing device(s) 216.

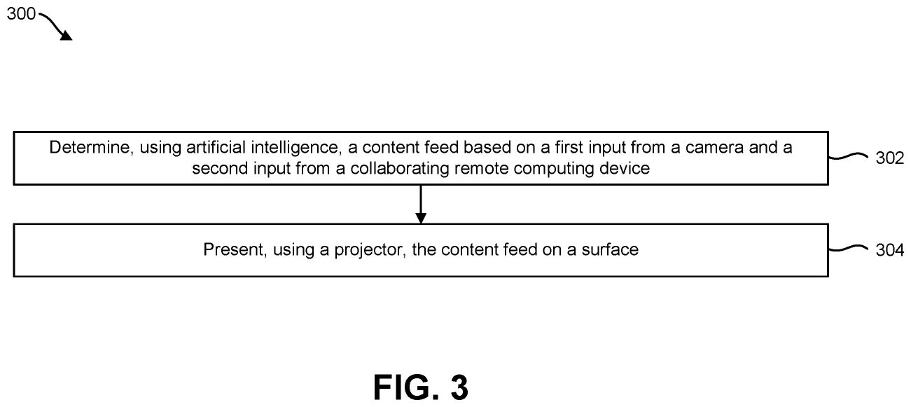

FIG. 3 is a flow diagram illustrating an example of a method 300 for surface presentations. The method 300 and/or a method 300 element or elements may be performed by a computing device. For example, the method 300 may be performed by the computing device 102 described in connection with FIG. 1, and/or by the computing device 202 described in connection with FIG. 2.

The computing device may determine 302, using artificial intelligence, a content feed based on a first input from a camera and a second input from a collaborating remote computing device. This may be accomplished as described in connection with FIG. 1 and/or FIG. 2. For example, the first input may be obtained from a camera on the computing device and the second input may be received from a collaborating remote computing device. The first input and the second input may be utilized to inform a search request and/or may be utilized to select content from search results for inclusion in the content feed.

The computing device may present 304, using a projector, the content feed on a surface. This may be accomplished as described in connection with FIG. 1 or FIG. 2. For example, the computing device may provide the content feed to a projector for presentation on a surface, such as a whiteboard.

In some examples, the computing device may send the content feed to the collaborating remote computing device. For instance, the computing device may send the content feed over a network to the collaborating remote computing device, which may present the content feed on a display.

In some examples, the computing device may convert writing from the first input. This may be accomplished as described in connection with FIG. 1 and/or FIG. 2. For example, the computing device may utilize artificial intelligence to recognize writing indicated in the first input from the camera. The computing device may generate text (e.g., character string(s)) based on the recognized writing. In some examples, the computing device may send (e.g., stream) the converted writing to the collaborating remote computing device. For example, the computing device may send text (e.g., code corresponding to characters) to the remote collaborating device. In some examples, the remote collaborating device may present the converted writing. In some examples, the remote collaborating device may present the converted writing instead of an image of the writing.

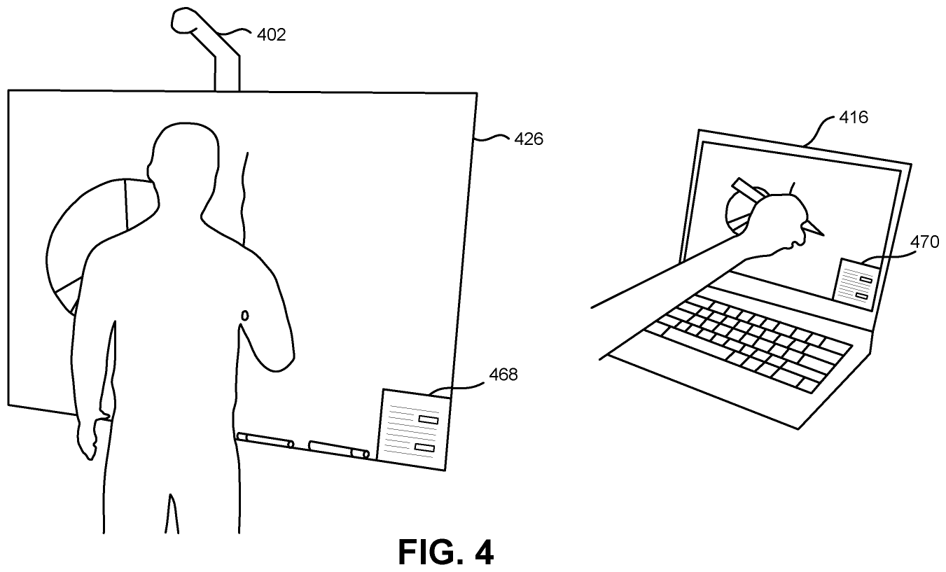

FIG. 4 is a diagram illustrating an example of a computing device 402, a surface 426, and a remote computing device 416. The computing device 402 may be an example of the computing device 102 described in connection with FIG. 1 and/or of the computing device 202 described in connection with FIG. 2. For example, the computing device 402 may determine and project and content feed 468 on the surface 426.

The remote computing device 416 may be an example of the remote computing device 216 described in connection with FIG. 2. For example, the remote computing device 216 may receive and present a content feed 470.

In some examples, a remote collaboration participant can see a representation of the surface 426 (e.g., whiteboard) using the remote computing device 416. In some examples, the remote computing device 416 may receive input with a touchscreen (with a finger or stylus, for instance). The input may represent writing, which may be sent to the computing device 402. The computing device 402 may project the input from the remote computing device 416 on the surface 426. For example, the participant's written contributions may be projected by the computing device 402 on top of the whiteboard marker text and images. Accordingly, a remote participant may use a touchscreen device to collaborate with a local participant at the surface 426. The use of the computing device 402 may create a hybrid interface that includes the surface 426 with projected images. This may enable online collaboration with remote participants.

Some of the techniques described herein may be beneficial by improving virtual collaboration capabilities. This may assist in business and educational contexts, which may increasingly demand collaboration among participants (e.g., teams, workers, students, and/or teachers, etc.) in different offices and/or institutions across multiple geographical regions. Some of the techniques described herein may be helpful for contexts such as brainstorming sessions and project ideation meetings with employees collaborating from different offices. Some of the techniques described herein may be beneficial in consulting, management, and/or technology development contexts. Some of the techniques described herein may be beneficial in educational contexts by increasing classroom access for remote students. For example, more students may be enabled to provide input remotely (online and/or in near real-time, for instance) and/or to participate in live lectures.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A computing device, comprising:
machine-readable instructions stored in a non-transitory storage medium, wherein the instructions are executable by a processor to:
determine a content feed using artificial intelligence based on a captured image of a writing surface; and
present the content feed with a representation of the writing surface.

2. The computing device of claim 1, further comprising a projector, wherein the processor is to present the content feed using the projector.

3. The computing device of claim 1, wherein the processor is to recognize writing on the writing surface based on the captured image.

4. The computing device of claim 3, wherein the processor is to use the artificial intelligence to determine the content feed based on the recognized writing.

5. The computing device of claim 3, wherein the processor is to use the artificial intelligence to select content from a network based on the recognized writing for the content feed.

6. The computing device of claim 3, wherein the processor is to generate text based on the recognized writing and to send the text to a remote computing device.

7. The computing device of claim 1, further comprising a camera to provide the captured image of the writing surface, wherein the captured image includes writing on the writing surface, and wherein the processor is to project an image of the writing onto the writing surface using a projector.

8. The computing device of claim 1, wherein the processor is to receive a set of inputs from a set of collaborating remote computing devices, and to use the artificial intelligence to determine a relevance for each of the set of inputs.

9. The computing device of claim 1, wherein the processor is to filter out a first input with a first relevance that is less than a relevance threshold.

10. A computing device, comprising:
a projector;
a camera;
a processor;
a memory in electronic communication with the processor;
instructions stored in the memory, the instructions being executable to:
receive, from the camera, a first input corresponding to a surface;
receive a second input from a collaborating remote computing device;
determine, using artificial intelligence, whether the second input is germane to the first input; and
present, using the projector, the second input on the surface in response to determining that the second input is germane to the first input.

11. The computing device of claim 10, wherein the instructions are executable to determine whether the second input is germane to the first input based on recognizing writing of the first input.

12. The computing device of claim 11, wherein the instructions are executable to:
determine a content feed based on the first input; and
present, using the projector, the content feed on the surface.

13. A method, comprising:
determining, using artificial intelligence, a content feed based on a first input from a camera and a second input from a collaborating remote computing device; and
presenting, using a projector, the content feed on a surface.

14. The method of claim 13, further comprising sending the content feed to the collaborating remote computing device.

15. The method of claim 13, further comprising:
converting writing from the first input; and
sending the converted writing to the collaborating remote computing device.
